(19) United States
(12) Patent Application Publication
(10) Pub. No.: US 2024/0081308 A1
(43) Pub. Date: Mar. 14, 2024

(54) DUAL-BEARING REEL

(71) Applicant: GLOBERIDE, Inc., Tokyo (JP)

(72) Inventors: Tomoaki SAKIYAMA, Tokyo (JP); Daisuke HIGUCHI, Tokyo (JP)

(21) Appl. No.: 18/240,044

(22) Filed: Aug. 30, 2023

(30) Foreign Application Priority Data
Sep. 8, 2022 (JP) 2022-142666

(51) Int. Cl. A01K 89/015

(52) U.S. Cl. CPC A01K 89/0193

(57) ABSTRACT

A dual-bearing reel comprises a spool rotatably supported between a left side plate and a right side plate of a reel main body, a handle provided on one of the left and right side plates to rotationally drive the spool, and an adjustment dial provided on a side plate on the opposite side of the handle. The side plate on the opposite side of the handle rotatably supports the adjustment dial on substantially the same axis as a rotation axis of the spool, and comprises an opening that exposes an arc region above the supported adjustment dial, and a cover portion is formed on an upper surface side of the side plate on the opposite side of the handle, the cover portion covering an outer peripheral surface on a front side of the adjustment dial and exposing an outer peripheral surface on a rear side thereof.

### CROSS-REFERENCE TO RELATED APPLICATION

This application claims priority under 35 U.S.C. § 119 to Japanese Patent Application No. 2022-142666 filed on Sep. 8, 2022 in the Japanese Patent Office, the entire contents of each hereby incorporated by reference.

### FIELD

The present disclosure relates to a dual-bearing reel in which a spool around which a fishing line is wound is rotatably supported between a left side plate and a right side plate constituting a reel main body.

### BACKGROUND

In general, a dual-bearing reel includes a left side plate and a right side plate in which side plates (also referred to as cover members) are detachably attached to left and right frames, respectively. A spool around which a fishing line is wound is rotatably supported between the left and right side plates, and a handle disposed on a side of one of the side plates is wound to rotationally drive the spool to wind the fishing line. As the dual-bearing reel, there are a left handle type in which the handle is disposed on the left side plate and a right handle type in which the handle is disposed on the right side plate.

As disclosed in JP 2017-123802 A, for example, a dual-bearing reel is known which has good gripping comfort and is downsized so that a side plate opposite to the handle is gripped together with a fishing rod to perform a casting operation, a braking force adjustment operation of the spool, and the like.

In this known dual-bearing reel, an adjustment dial for adjusting a braking force acting on the spool is disposed on a front side of the side plate on the opposite side of the handle, and the adjustment dial is supported such that an arc region of about half of the upper side is exposed.

The adjustment dial is rotationally operated to operate constituent members of a braking force adjustment mechanism to adjust the braking force acting on the spool, and is frequently operated before the cast operation of the lure, for example, by replacing the lure or considering the influence of wind.

### SUMMARY

Since the adjustment dial of the dual-bearing reel is disposed on the front side of the side plate, it is difficult to perform the rotation operation of the adjustment dial with the finger of the hand grasping the side plate on the opposite side of the handle. In consideration of the disposing position of the adjustment dial, it is necessary to extend the thumb of the hand grasping the reel main body forward together with the fishing rod, but in such a state, it is difficult to perform the rotation operation. When the braking force is adjusted, it is necessary to perform the rotation operation by regrasping the reel main body, and it cannot be said that the operability is good. In addition, since the adjustment dial is disposed on the front side of the side plate, there is a limit in downsizing the entire reel.

The present disclosure has been made in view of the above problems, and an object thereof is to provide a dual-bearing reel in which an adjustment operation of a braking force acting on a spool can be easily performed and the entire reel can be downsized.

In order to achieve the above object, a dual-bearing reel according to the present disclosure comprises a spool rotatably supported between a left side plate and a right side plate of a reel main body, a handle provided on one of the side plates to rotationally drive the spool, and an adjustment dial provided on a side plate on an opposite side of the handle to adjust a braking force with respect to rotation of the spool, in which the side plate on the opposite side of the handle rotatably supports the adjustment dial on substantially a same axis as a rotation axis of the spool, and comprises an opening that exposes an arc region above the supported adjustment dial, and a cover portion is formed on an upper surface side of the side plate on the opposite side of the handle, the cover portion covering an outer peripheral surface on a front side of the adjustment dial where the arc region is exposed and exposing an outer peripheral surface on a rear side of the adjustment dial.

In the dual-bearing reel having the above-described configuration, the opening is formed in the side plate on the opposite side from the handle, and the adjustment dial for adjusting the braking force acting on the spool rotation is disposed inside the opening. Since the adjustment dial is rotationally operated to adjust the braking force and is rotatably supported on substantially the same axis as the rotation axis of the spool, the side plate does not largely protrude forward, and the side plate can be downsized in a front-rear direction. In addition, since the adjustment dial is disposed on the rear side of the side plate, when the reel main body is gripped together with the fishing rod, the thumb placed on the upper surface of the side plate on the opposite side of the handle can be brought into contact with the exposed region where the adjustment dial is not covered by the cover portion only by moving the thumb in the lateral direction, and the rotation operation of the adjustment dial can be performed without changing the hand. In this case, since the outer peripheral surface on the front side of the adjustment dial is covered by the cover portion, the thumb is not erroneously brought into contact with the adjustment dial, and erroneous operation can be prevented.

According to the present disclosure, it is possible to obtain a dual-bearing reel capable of easily performing the adjustment operation of the braking force acting on the spool, and miniaturizing the entire reel.

### BRIEF DESCRIPTION OF THE DRAWINGS

FIG. 1 is a plan view illustrating an embodiment of a dual-bearing reel according to the present disclosure;

FIG. 2 is a side view of the dual-bearing reel illustrated in FIG. 1 as viewed from an opposite side of a handle;

FIG. 3A is a view of an adjustment dial as viewed from a rear side, and FIG. 3B is an enlarged cross-sectional view of a cover portion covering an adjustment dial portion;

FIG. 4 is a view illustrating a state in which the dual-bearing reel illustrated in FIG. 1 is attached to a fishing rod;

FIG. 5 is a view illustrating a state in which a reel main body is held together with a fishing rod and the adjustment dial is operated; and

FIGS. 6A and 6B illustrates an operation mode of the adjustment dial, in which FIG. 6A is a view illustrating a state in which the reel main body is held together with a fishing rod, and FIG. 6B is a view of a state in which the adjustment dial is operated as viewed obliquely from above.

### DETAILED DESCRIPTION

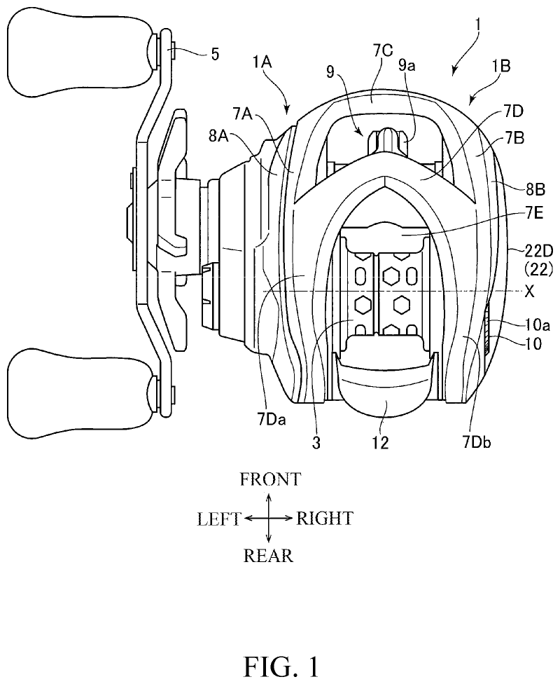

Hereinafter, an embodiment of a dual-bearing reel according to the present disclosure will be described with reference to FIGS. 1 to 6B.

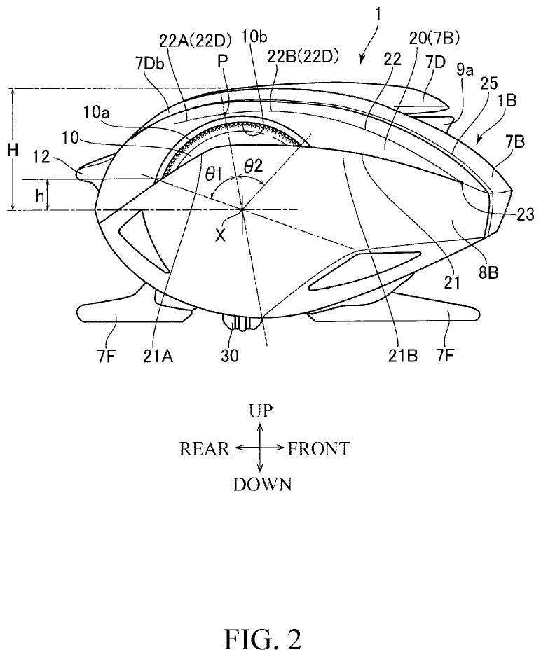

Note that, in the following description, a front-rear direction, a left-right direction, and an up-down direction are defined as directions illustrated in FIGS. 1 and 2.

A reel main body 1 of the dual-bearing reel according to the present embodiment comprises a left side plate 1A, a right side plate 1B, and a spool 3 that is rotatably supported between both side plates 1A and 1B. In the present embodiment, a handle 5 is provided on the left side plate 1A side, and the spool 3 is rotationally driven via a driving force transmission mechanism (not illustrated) disposed in the left side plate by winding the handle 5 (left handle type). Note that the handle 5 may be provided on the right side plate side.

The reel main body 1 comprises a frame constituting the left and right side plates 1A and 1B and a side plate attached to the frame. The frame comprises a left frame 7A and a right frame 7B, which are integrally formed. Further, a left side plate 8A (left cover member) is attached to the left frame 7A, and a right side plate 8B (right cover member) is attached to the right frame 7B. Thus, the left side plate (handle-side side plate) 1A comprises the left frame 7A and the left side plate 8A attached to the left frame 7A, and the right side plate (opposite handle-side side plate) 1B comprises the right frame 7B and the right side plate 8B attached to the right frame 7B.

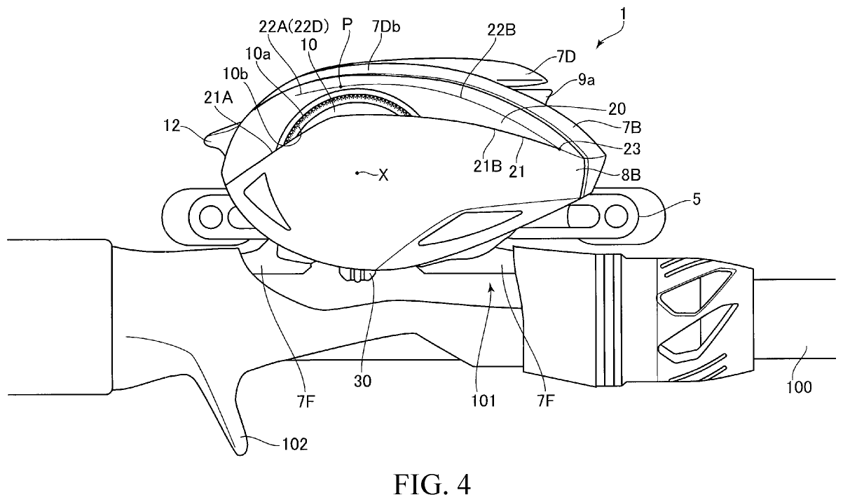

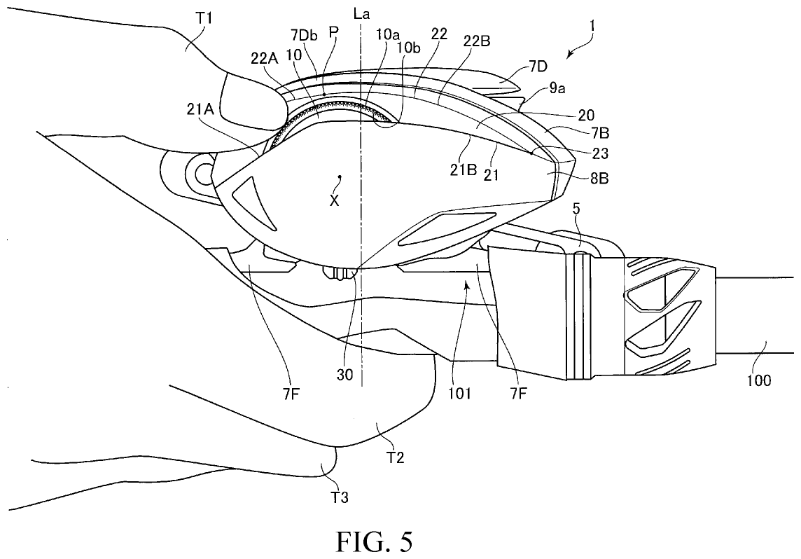

The frame 7 comprises a plurality of connecting portions that connect the left frame 7A and the right frame 7B, for example, a front connecting portion 7C, an upper connecting portion (which may function as a thumb rest) 7D, and a lower connecting portion 7E. Among these connecting portions, a reel leg 7F to be attached to a reel seat 101 of a fishing rod 100 (see FIGS. 4 and 5) is integrally formed with a lower connecting portion 7E provided below the spool.

The shapes of the left and right side plates 1A and 1B are not limited, but the left and right side plates 1A and 1B of the present embodiment are configured so that an outer peripheral shape is a non-circular shape (substantially elliptical shape) extending in the front-rear direction in a side view (see FIG. 2). Note that, although the left and right side plates may have substantially the same shape, in a case where a large drive gear is used as a drive gear of the driving force transmission mechanism, the side plate on the side where the drive force transmission mechanism is disposed (side plate on the handle side) may not have substantially the same shape, such as swelling in the front-rear direction with respect to the side plate on the opposite side of the handle.

In the present embodiment, a known driving force transmission mechanism that transmits the rotation of the handle 5 to the spool 3, a known drag mechanism that adjusts the braking force with respect to the free rotation of the spool 3, and the like are accommodated between the left frame 7A and the left side plate 8A constituting the side plate (left side plate 1A) on the handle side. In addition to the driving force transmission mechanism and the drag mechanism, various functional components such as a power transmission gear for a level wind device 9 that reciprocally drives a fishing line guide 9a disposed in front of the spool 3 to the left and right and a reverse rotation prevention mechanism that is disposed on the handle shaft and prevents reverse rotation of the handle shaft are accommodated in the left side plate 1A.

A known braking force adjustment mechanism that adjusts the braking force acting on the rotation of the spool 3 is accommodated in the side plate (right side plate 1B) on the opposite handle side. The braking force adjustment mechanism is configured to be able to adjust the braking force acting on the rotation of the spool 3, and can be configured by, for example, a magnetic braking system. In this case, an adjustment dial 10 for adjusting the braking force is supported in a state of being exposed on the surface of the side plate on the opposite side of the handle (right side plate 8B), and in the present embodiment, a rotation center (support portion) of the adjustment dial 10 is placed so as to be on the same axis as a rotation axis X of the spool 3.

Note that the braking force adjustment mechanism in which the adjustment dial 10 is placed on the same axis as the rotation axis X of the spool 3 has a known configuration, and the specific configuration of the braking force adjustment mechanism is not particularly limited in the present disclosure. For example, by disposing a brake magnet and a conductor in the inner space of the fishing line winding body of the spool 3, the support portion of the adjustment dial 10 can be supported on the same axis as the rotation axis X of the spool 3, and the braking force adjustment mechanism portion of the right side plate can be suppressed from swelling in an axial direction.

Further, a known clutch mechanism that switches the spool 3 to a free rotation state is disposed on one of the left and right side plates 1A and 1B. The clutch mechanism can switch from the clutch-ON state to the clutch-OFF state by pushing down the clutch lever 12 bridged between the left and right side plates on a rear side of the spool 3, and the spool 3 enters the free rotation state (fishing line release state). Return to the clutch-ON state can be done via a known automatic return mechanism by winding the handle 5.

The present disclosure is characterized in a disposing mode of the adjustment dial 10 of the braking force adjustment mechanism with respect to the side plate.

Hereinafter, the disposing mode of the adjustment dial and an operation mode thereof will be described.

An opening 20 is formed on the side surface on an upper surface side of the right side plate 8B constituting the side plate (right side plate 1B) on the opposite side of the handle so as to extend in the front-rear direction. The opening 20 penetrates the right side plate 8B, and the right frame 7B can be visually recognized through the opening. In this case, a bottom portion may be partially or entirely formed in the opening 20, or in a configuration in which a set plate that supports various functional components is disposed between the right side plate 8B and the right frame 7B, the set plate may be configured to be visible.

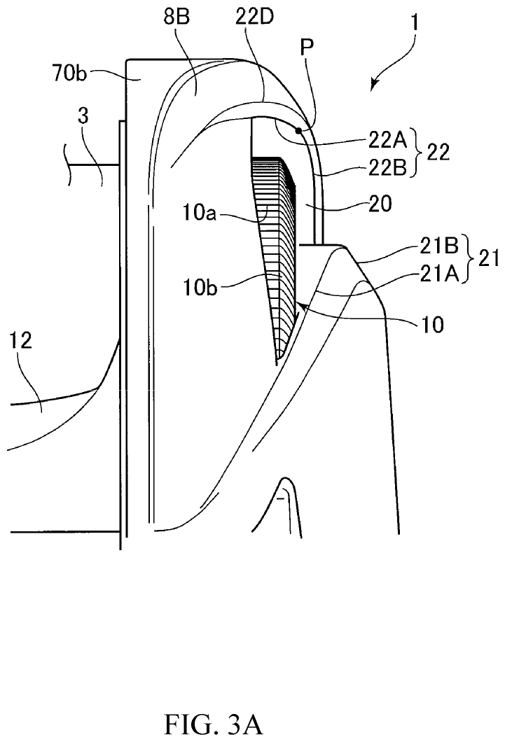

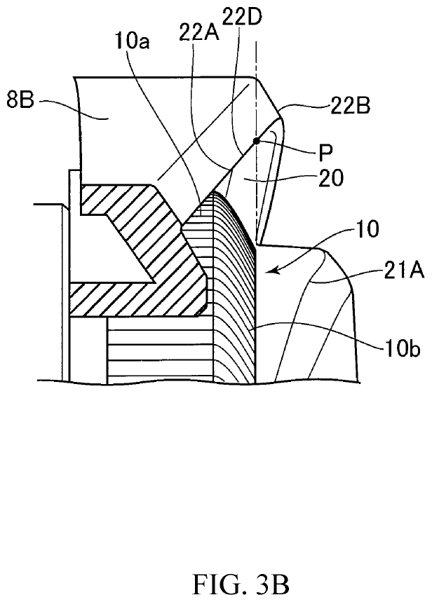

As illustrated in FIG. 2, the opening 20 is defined by a lower ridgeline 21 extending in the front-rear direction and an upper ridgeline 22 extending in the front-rear direction. The ridgelines 21 and 22 defining the opening 20 are edges visually recognized when viewed from the side, and are configured by end edges of portions having a slight thickness in the left-right direction (see FIGS. 3A and 3B).

The lower ridgeline 21 and the upper ridgeline 22 are each formed in a curved shape along the front-rear direction, and intersect and terminate at an intersection 23 on the front end side. In addition, the lower ridgeline 21 and the upper ridgeline 22 are in an open state without intersecting on the rear end side. The adjustment dial 10 is rotatably supported on the right side plate 8B in a state where an upper arc region is exposed through the opening 20 when viewed from the side.

The lower ridgeline 21 is formed so that, on a rear side thereof, preferably, on a rear side of the rotation axis X of the spool, a ridgeline 21A on the rear side is lowered from a rear end of a ridgeline 21B on a front side, and the opening 20 is formed so as to open wider as it moves rearward (see FIGS. 2, 4, and 5). Thus, the opening 20 is formed so that an exposure range on the rear side of the adjustment dial 10 is larger than an exposure range on the front side (θ1>θ2 to be described later).

The upper ridgeline 22 is an end edge of a cover portion 22D that covers an outer peripheral surface 10a on the front side of the adjustment dial 10 in which the arc region is exposed. The cover portion 22D covers the outer peripheral surface 10a on the front side of the adjustment dial 10, and is integrally formed with the right side plate 8B so as to allow contact with the outer peripheral surface 10a of the adjustment dial 10 when the thumb is shifted to the side in a state where the thumb is in contact with a surface region 7Db near the rotation axis of the spool 3 on a side portion of the upper connecting portion (thumb rest) 7D of the frame 7.

Thus, as illustrated in FIGS. 3A and 3B, the upper ridgeline 22 is formed so as to gradually protrude laterally as it shifts forward. On the front side, when the thumb is in contact with the surface region 7Db is shifted laterally, the upper ridge line is formed so that it is hard to contact with (preferably not to contact with) the outer peripheral surface 10a of the adjustment dial 10, and on the rear side, it is possible to contact with the outer peripheral surface 10a of the adjustment dial 10.

Here, a configuration of the cover portion 22D defined by the upper ridgeline 22 will be described.

As described above, the cover portion 22D is configured to cover the front side of the exposed arc region of the adjustment dial 10 to make it difficult for a finger to touch, and to open the arc region on the rear side to make it easy for a finger to touch. As illustrated in FIGS. 3A and 3B, the adjustment dial 10 is configured such that irregularities are formed on the outer peripheral surface 10a and fingers are easily hooked, and is further configured such that irregularities are also formed on a radially outer annular region 10b and fingers are easily hooked.

Note that, in FIG. 3B, a boundary point between a position where the cover portion 22D covers the adjustment dial 10 and a position where the cover portion does not cover the adjustment dial 10 is indicated by a reference sign P.

As described above, the support portion of the adjustment dial 10 is disposed at the position coinciding with the rotation axis X of the spool 3, and the support portion (rotation axis X) of the present embodiment is set such that the holding portion (rotation axis X) is on a rear side with respect to a center line La in the front-rear direction of the side plate 1B as illustrated in FIG. 5.

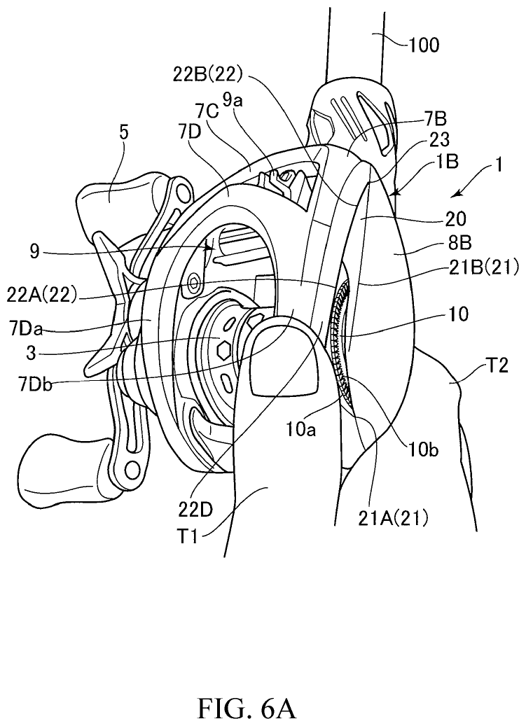

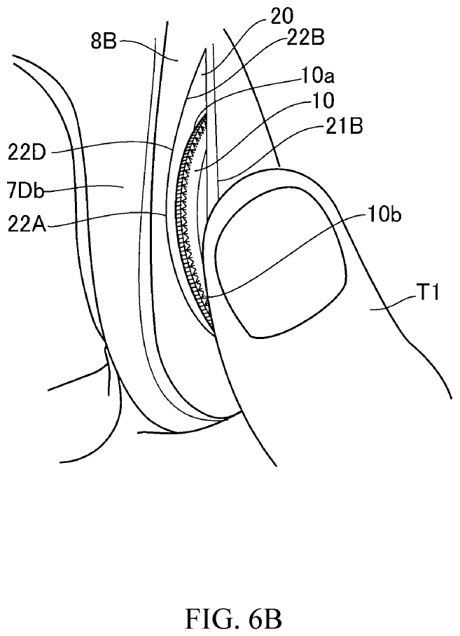

By setting the support portion of the adjustment dial 10 to the position illustrated in FIG. 5, the adjustment dial 10 is shifted rearward. Therefore, there is no need to form the side plate 1B in a shape projecting forward, and the reel main body (the entire reel) can be downsized. In general, when a lure or the like is cast, the reel main body 1 is gripped with two fingers of the index finger T2 and the ring finger T3 hooked on a front side of a trigger 102 formed on the reel seat 101 (see FIG. 6A), and in this state, the thumb T1 is shifted in the left-right direction as it is, and pushing down of the surface regions 7Da and 7Db on both sides of the thumb rest of the reel main body 1 and the clutch lever 12, thumbing operation of the surface of the fishing line wound around the spool 3, and the like are performed.

In such an operation, since the support portion of the adjustment dial 10 is placed on the rear side of the center line La in the front-rear direction of the side plate on the opposite side of the handle, the thumb placed on the surface region 7Db is shifted to the side as it is, and the rotation operation of the adjustment dial 10 can be easily performed. In particular, by making the supporting position of the adjustment dial 10 coincide with the rotation axis X of the spool 3, the thumb T1 in contact with the spool surface around which the fishing line is wound or the surface region 7Db of the thumb rest can come in contact with the outer peripheral surface of the adjustment dial 10 only by shifting the thumb T1 laterally as it is in a state where the reel main body 1 is grasped. Thus, before the casting operation, the rotation operation of the adjustment dial 10 (adjustment operation of the braking force of the spool 3) is performed with the thumb of the hand grasping the reel main body 1 together with the fishing rod 100, and subsequently, a series of operations of the clutch OFF operation and the thumbing operation can be easily performed without changing the hand (see FIGS. 5 to 6B).

In addition, since the cover portion 22D formed on the right side plate 8B covers the front side of the adjustment dial and does not cover the wide opening on the rear side, the thumb of the hand gripping the reel main body 1 together with the fishing rod 100 is easily hooked on the adjustment dial 10 from the rear side, and it is possible to suppress an erroneous operation while facilitating the adjustment operation. In addition, in the present embodiment, since the opening 20 exposes the arc region of the upper half of the adjustment dial 10 and exposes only the portion necessary for the operation, the operation of the adjustment dial can be easily performed, and the erroneous operation can be effectively prevented.

Note that, in the cover portion 22D, it is preferable that a range covering the outer peripheral surface of the adjustment dial 10 with the support portion (rotation axis X) of the adjustment dial 10 as the center is formed in a range smaller than a range not covering the outer peripheral surface. Specifically, with respect to the adjustment dial 10, the position of the boundary point P between the range not covered by the cover portion 22D and the range covered is preferably formed so that the exposure range θ1 on the rear side of the adjustment dial 10 is larger than the exposure range θ2 on the front side (θ1>θ2; see FIG. 2).

In this manner, by making the exposure range on the rear side wider than the exposure range on the front side, the adjustment operation of the adjustment dial can be facilitated. In this case, the ratio between θ1 and θ2 is preferably set to θ1>θ2 as described above, and specifically, θ1 and θ2 are preferably set to about 60:40 so that it is possible to have good operability and suppress erroneous operation. Thus, if θ1+θ2 is set to, for example, 120°, it is preferable to set θ1+θ2 to about 70°<θ1<75°.

Further, the opening 20 is preferably formed at an appropriate position in relation to the height of the side plate 1B. That is, when it is formed at an excessively high position or a low position, it is difficult to hook a finger on the adjustment dial and the operability is deteriorated, or a possibility of erroneous operation increases. Thus, when the height from the position of the support portion (rotation axis X) of the adjustment dial 10 to the highest position of the side plate on the opposite side of the handle is H, and the height from the position of the support portion of the adjustment dial 10 to the lowest position where the adjustment dial is exposed is h, it is preferable to form the opening 20 to satisfy 0.2H≤h≤0.4H.

The embodiment according to the present disclosure has been described above, but the disclosure is not limited to the embodiment and may be modified in various ways.

For example, the position and shape of the opening 20 formed in the side plate on the opposite side of the handle are not particularly limited. Further, the side plate on the opposite side of the handle may be configured to be openable and closable with respect to the frame by an opening and closing mechanism comprising a locking device. Such an opening and closing mechanism is known, and in the present embodiment, for example, the right side plate 8B can be opened and closed with respect to the frame by operating an operating member 30 provided on the lower surface of the side plate 1B on the opposite side of the handle.

In the side plate on the opposite side of the handle, the adjustment dial 10 is disposed so that the support portion thereof is on the same axis as the rotation axis X of the spool 3, but may not exactly coincide with the rotation axis X (as long as it is on substantially the same axis slightly shifted in the radial direction). In addition, the size, shape, and thickness of the adjustment dial 10 are not limited, and even if the support portion does not exist on substantially the same axis as the rotation axis X, the support portion only needs to exist behind the intermediate position La of the length in the front-rear direction of the side plate according to the structure of the braking force adjustment mechanism. Even at such a position, it is possible to suppress the side plate from protruding forward.

In addition, as illustrated in FIG. 3B, the cover portion 22D covering the front side of the adjustment dial 10 described above is formed so as to protrude axially outward in a continuous curved shape as it shifts forward, but it is possible to appropriately modify the cover portion such that the cover portion protrudes stepwise or protrudes axially outward in a linear shape.

What is claimed is:

1. A dual-bearing reel, comprising:
a spool rotatably supported between a left side plate and a right side plate of a reel main body; a handle provided on one of the side plates to rotationally drive the spool; and an adjustment dial provided on a side plate on an opposite side of the handle to adjust a braking force with respect to rotation of the spool, wherein
the side plate on the opposite side of the handle rotatably supports the adjustment dial on substantially a same axis as a rotation axis of the spool, and comprises an opening that exposes an arc region above the supported adjustment dial, and
a cover portion is formed on an upper surface side of the side plate on the opposite side of the handle, the cover portion covering an outer peripheral surface on a front side of the adjustment dial where the arc region is exposed and exposing an outer peripheral surface on a rear side of the adjustment dial.

2. A dual-bearing reel, comprising:
a support portion of the adjustment dial that is provided on a rear side of a center line in a front-rear direction of the side plate on the opposite side of the handle.

3. The dual-bearing reel according to claim 1, wherein
in the cover portion, a range covering an outer peripheral surface of the adjustment dial with the support portion of the adjustment dial as a center is formed smaller than a range not covering the outer peripheral surface.

4. The dual-bearing reel according to claim 1, wherein
when a height from a position of the support portion of the adjustment dial to a highest position of the side plate on the opposite side of the handle is H, and a height from the position of the support portion of the adjustment dial to a lowest position where the adjustment dial is exposed is h, the opening is formed to satisfy 0.2H≤h≤0.4H.
